(19) United States
(12) Patent Application Publication
(10) Pub. No.: US 2019/0123785 A1
(43) Pub. Date: Apr. 25, 2019

(54) Electronic Part and Method for Supplying the Latter with Electrical Energy

(71) Applicant: Robert Bosch GmbH, Stuttgart (DE)

(72) Inventors: Sebastian Vornwald, Wuerzburg (DE); Adrien Mouaffo Tiadjio, New-Ulm (DE); Christoph Maier, Kleinostheim (DE); Jochen Mueller, Backnang (DE); Patric Brand, Sennfeld (DE); Peter Rehbein, Erlabrunn (DE); Roman Ritter, Stuttgart (DE); Thomas Inderwies, Frammersbach (DE); Wolfgang Rueppel, Frammersbach (DE)

(21) Appl. No.: 16/168,261

(22) Filed: Oct. 23, 2018

(30) Foreign Application Priority Data
Oct. 23, 2017 (DE) 10 2017 218 850.2

(51) Int. Cl. H04B 5/00

(52) U.S. Cl. CPC H04B 5/0037; H04B 5/0093

(57) ABSTRACT

An electronic part includes at least one near-field communication module, and at least one electronic component. The at least one electronic component is connected to the at least one near-field communication module such that the at least one electronic component is configured to be supplied with electrical energy via the at least one near-field communication module.

This application claims priority under 35 U.S.C. § 119 to patent application no. DE 10 2017 218 850.2, filed on Oct. 23, 2017 in Germany, the disclosure of which is incorporated herein by reference in its entirety.

### BACKGROUND

It is known practice to contactlessly interchange information with electronic devices using near-field communication. Near-field communication is used, for example, to interchange payment information between a credit card and a cash register or for pairing with Bluetooth® devices.

In the case of near-field communication, it is regularly necessary for the electronic device to have an energy supply, for example a battery. A cable connection to the electronic part is required for a supply with electrical energy which goes beyond a supply by means of a battery and also for charging the battery.

Accordingly, electronic parts which are used for near-field communication (so-called “NFC tags”) can be equipped only with very economical microcontrollers and only with very minimal software functions.

### SUMMARY

On the basis of this, the object of the present disclosure is to solve or at least reduce the technical problems described in connection with the prior art. In particular, the intention is to present an electronic part and a method for supplying the latter with electrical energy which make it possible to carry out even energy-intensive processes on the electronic part.

This object is achieved with an electronic part and a method for supplying the latter with electrical energy according to this disclosure. Advantageous configurations of the electronic part and of the method are stated in the claims, description, and drawings. The features individually disclosed can be combined with one another in any desired, technologically useful manner and can be supplemented with explanatory facts from the description, wherein further embodiment variants of the disclosure are shown.

An electronic part is presented, said part at least comprising:
at least one near-field communication module, and
at least one electronic component which is connected to the near-field communication module in such a manner that the at least one electronic component can be at least occasionally supplied with electrical energy via the near-field communication module.

Near-field communication is also known as NFC for short. During near-field communication, electromagnetic signals are interchanged over short distances of up to 5 cm, for example. The near-field communication module can also be referred to as an NFC module for short. The near-field communication module preferably has at least one coil and a near-field microprocessor. The coil can be used to receive a signal which can be converted via the near-field microprocessor into a signal which can be processed further by the electronic part or its elements.

The electronic part also comprises at least one electronic component which is connected to the near-field communication module in such a manner that the at least one electronic component can be at least occasionally supplied with electrical energy via the near-field communication module.

Energy is transferred to the electronic part via a signal received using the near-field communication module. Within the scope of the definition of the expressions which is used here, the transfer of energy by means of a signal comprises both the transmission of information and the supply with energy. Energy is input even in the case of conventional information transmitted using electromagnetic signals. Such input of energy alone is not intended to be understood here as meaning a supply with energy. A supply with energy is present (only) when the energy input via the signal significantly exceeds the amount needed to transmit the at least one item of information. A supply with energy is present, in particular, when no further energy source, for example a battery, is provided or has been disconnected from the at least one electronic component at a particular time.

In particular, the supply of the at least one electronic component with energy should be understood as meaning the fact that not only the near-field communication module (comprising the coil and parts for operating the coil (alone)) is supplied with energy. A supply of an electronic component which is not the near-field communication module itself is not (directly) part of near-field communication. During near-field communication, only the near-field communication module or the near-field microprocessor is supplied with energy. In contrast, in the case of the electronic part described, energy can be coupled out of the near-field communication and can be forwarded to the at least one electronic component. Such coupling-out of energy is not provided in conventional near-field communication.

The omission of an energy supply for the at least one electronic component as additional electronics and the omission of cables and connectors can considerably simplify a housing structure for the electronic part and can also have a positive effect, in particular, with respect to impermeability, resistance and/or longevity. In addition, battery-operated electronic parts can also be used beyond the lifetime of the battery.

In one preferred embodiment of the electronic part, the at least one electronic component is one of the following:
a sensor,
a communication interface,
a computing module.

The electronic part may be intended and set up, in particular, to record one or more measurement variables and to transmit them to a data network. In particular, a temperature, a magnetic field (which can be characterized by a direction and/or a magnitude), an acceleration (which can be characterized by a direction and/or a magnitude) and/or a light intensity can be measured. The electronic part preferably comprises at least one corresponding sensor. The electronic part may be referred to as a sensor part.

It is also preferred for the electronic part to be designed in such a manner that measured values recorded using the sensors can be transmitted in a contactless manner, for example using radio, Bluetooth, WLAN, infrared or mobile radio. The electronic part preferably has an accordingly designed communication interface. In such a configuration, in particular in conjunction with the above-described configuration with one or more sensors, the electronic part can also be referred to as a “sensor connectivity device”.

The communication interface may be, in particular, a transmitter and/or a receiver for radio, Bluetooth, WLAN, infrared or mobile radio. The communication interface preferably comprises at least one antenna. The communication interface differs from the near-field communication module. The communication interface is preferably suitable for transmitting data over a significantly greater distance than the near-field communication module.

The measured values recorded by the at least one sensor can be transmitted, after suitable processing, to the communication interface, in particular, via a microprocessor as a computing module. The computing module can control and monitor, in particular, the method of operation of the electronic part. The computing module can also be referred to as an arithmetic unit.

The electronic part is preferably intended and set up to be fitted, for example, to a machine tool, a production machine, a vehicle or an industrial plant. In this case, measured values can be measured at one or more different positions using one or more of the electronic parts described. For example, measured values can be recorded at valves for operating a machine or a plant. Acceleration values can be used, for example, to identify damage to a machine part, in particular as a result of a limit value being exceeded. The electronic part can also be provided on objects and/or shelves of a warehouse. Vibrations captured using the acceleration sensor can be used to identify damage to the stored objects and/or to the shelves.

The electronic part is preferably autonomous, with the result that there is no need, in particular, for a cable connection (either for supplying energy to the electronic part or for transmitting information) to the electronic part. This can be achieved, in particular, by virtue of the fact that a battery is provided in or on the electronic part.

It is also preferred for the electronic part to be closed in such a manner that no water can enter the electronic part from the outside, for example. In that case, it is preferred for the electronic part to not have a mechanical user interface, for example a switch, via which a user can interact with the electronic part. Instead, interaction between the user and the electronic part is preferably carried out in a contactless manner. This makes it possible to permanently avoid water entering the electronic part, for example.

In one preferred embodiment of the electronic part, a connection between the at least one near-field communication module and the at least one electronic component can be switched via at least one switch.

The at least one switch can preferably be switched (only) electronically. In particular, the at least one switch may be a transistor. The at least one switch is preferably controlled or actuated (only) via the near-field communication module.

The coil of the near-field communication module has an electrically conductive coil line which may be, for example, in the form of a thin metal layer on a printed circuit board or on a substrate or in the form of a wire. The coil line is preferably connected to the near-field microprocessor. For this purpose, the near-field microprocessor preferably has a first connection and a second connection. A signal received using the coil can therefore be processed further by the near-field microprocessor. In order to supply the at least one electronic component with energy, a respective supply is preferably connected to the first connection and to the second connection of the near-field microprocessor. The result is therefore a closed circuit comprising the coil line, the first of the supply lines, the at least one electronic component and a second of the supply lines.

The at least one switch is preferably provided in one of the supply lines. However, a respective switch may also be provided in each of the supply lines.

In one preferred embodiment of the electronic part, the at least one switch can be controlled via a signal which can be output by the at least one near-field communication module.

If the switch is in the form of a transistor, a gate connection of the switch is preferably connected to the near-field microprocessor. The near-field microprocessor preferably has a third connection which is intended and set up to control the at least one switch. The signal from the near-field microprocessor, which is used to control the switch, can be output via the third connection.

In one preferred embodiment of the electronic part, the at least one electronic component is also connected to the at least one near-field communication module via at least one feedback channel.

The feedback channel is preferably a connection between the at least one electronic component and the near-field microprocessor. The near-field microprocessor preferably has a fourth connection to which the feedback channel is connected. Information signals can be interchanged between the at least one electronic component and the near-field microprocessor via the feedback channel. For example, an information signal can be transmitted from the near-field microprocessor to the at least one electronic component, which changes the at least one electronic component to a predefined state. A status of the at least one electronic component can also be transmitted to the near-field microprocessor using a feedback signal via the feedback channel.

As a further aspect, a method for at least occasionally supplying at least one electronic component with electrical energy via at least one near-field communication module is presented, at least comprising the following method steps of:

a) receiving at least one request signal using the at least one near-field communication module,

b) outputting at least one connection signal by means of the at least one near-field communication module in order to establish a connection between the at least one near-field communication module and the at least one electronic component if the at least one request signal was received in step a),

c) outputting electrical energy by means of the at least one near-field communication module for the purpose of supplying the at least one electrical component.

The special advantages and configuration features described for the electronic part can be applied and transferred to the method and vice versa.

The at least one electronic component can be used, in particular, on request by a user. For this purpose, the user can transmit the at least one request signal to the electronic part in a transmission apparatus (for example in a smartphone or a tablet) using near-field communication. According to step a) of the described method, the at least one request signal can be received using the at least one near-field communication module. The at least one request signal can then be processed by the near-field microprocessor. This can be carried out, in particular, in such a manner that the at least one switch is closed in order to supply the at least one electronic component with energy.

Step b) of the described method therefore provides for the at least one near-field communication module to output at least one connection signal in order to establish a connection between the at least one near-field communication module and the at least one electronic component if the at least one request signal was received in step a).

The connection between the at least one near-field communication module and the at least one electronic component can be formed via the connecting lines, in particular. This connection can be established, in particular, by closing the at least one switch. The at least one connection signal is therefore preferably intended and set up to close the at least one switch. If the switch is in the form of a transistor, the connection signal is preferably applied to a gate of the transistor. The at least one connection signal is preferably output via the third connection of the near-field microprocessor.

In step c) of the described method, the at least one near-field communication module outputs electrical energy for the purpose of supplying the at least one electronic component.

The electrical energy can be output, in particular, to the at least one electronic component by virtue of a signal received using the coil of the near-field communication module being at least partially forwarded to the at least one electronic component via the supply lines. The electrical energy can thus be made available to the at least one electronic component as an electrical (direct or alternating) current, in particular.

The energy which can be transferred to the at least one electronic component according to the described method preferably comes from an energy source. The energy source may be, for example, a battery in the transmission apparatus. This is particularly preferred if the transmission apparatus is mobile, as is the case with a smartphone or a tablet, for example. However, it is also possible for the transmission apparatus to be connected to the public electricity network accessible via sockets via a cable connection, for example.

In one preferred embodiment of the method, an electrical power which is used to transfer electrical energy from an energy source to the at least one near-field communication module is increased before step a).

The power which is used to transfer the electrical energy to the at least one near-field communication module results, in particular, from a signal strength of a signal interchanged between the transmission apparatus and the near-field communication module. The energy received by the near-field communication module is fundamentally used to supply the near-field microprocessor. In addition, the at least one electronic component is also supplied according to the described method. The power required for this purpose may be substantially higher than the power needed to supply the near-field microprocessor. If near-field communication is used only to interchange information between the transmission apparatus and the electronic part, a substantially lower transmission power may therefore suffice than in a situation in which the at least one electronic component is additionally supplied with energy. In the present embodiment, a transmission power of the transmission apparatus is therefore preferably increased such that the transmission power suffices for the additional energy consumption by the at least one electronic component. If the at least one electronic component is no longer supplied with energy, that is to say after step c) in particular, the power which is used to transfer electrical energy from the energy source to the at least one near-field communication module is preferably reduced again, in particular to a value which was available before the increase before step a).

The electronic part is preferably notified by near-field communication that the energy source increases the transmission power and the at least one electronic component (that is to say attached additional electronics) is intended to be enabled. The at least one (in particular electronically controllable) switch can then be enabled. In addition to the near-field communication module, the energy can therefore additionally supply the at least one electronic component (for example the computing module, sensors and/or a communication interface) with electrical energy.

The at least one electronic component preferably notifies the transmission apparatus of its status via the communication interface and the feedback to the energy source is therefore self-contained.

In another preferred embodiment, the method also comprises the following method step of: d) receiving at least one feedback signal from the at least one electronic component using the at least one near-field communication module.

The at least one feedback signal can be used to transmit a status of the at least one electronic component to the near-field microprocessor, in particular via the feedback channel.

As a further aspect, a transmission apparatus is presented, which transmission apparatus is set up to supply an electronic part with electrical energy using the described method.

The special advantages and configuration features described for the electronic part and for the method can be applied and transferred to the transmission apparatus.

As a further aspect, a use of a near-field communication module to supply at least one electronic component of an electronic part with electrical energy is presented.

In particular, the electronic part described and the method described can be used to operate work machines.

The special advantages and configuration features described further above for the electronic part and for the method can be applied and transferred to the use and vice versa.

### BRIEF DESCRIPTION OF THE DRAWINGS

The disclosure and the technical environment are explained in more detail below on the basis of the figures. The figures show an exemplary embodiment, but the disclosure is not restricted thereto. For the purposes of clarification, it is pointed out that the technical features illustrated in the figures can also be combined with features from other figures and/or the description without the need to adopt other technical features from a figure. If there is a technical need to combine forms of a technical feature with those of another feature, reference is explicitly made thereto, such that there is otherwise an ability to freely combine these features.

In the drawings:

FIG. 1: schematically shows an illustration of an electronic part,

FIG. 2: schematically shows an enlarged illustration of a near-field communication module and of an electronic component of the electronic part from FIG. 1, and

FIG. 3: schematically shows an illustration of a work machine having a plurality of electronic parts according to the embodiment from FIGS. 1 and 2, and

FIG. 4: schematically shows an illustration of a method for supplying the electronic components of the electronic part from FIGS. 1 and 2 with electrical energy.

### DETAILED DESCRIPTION

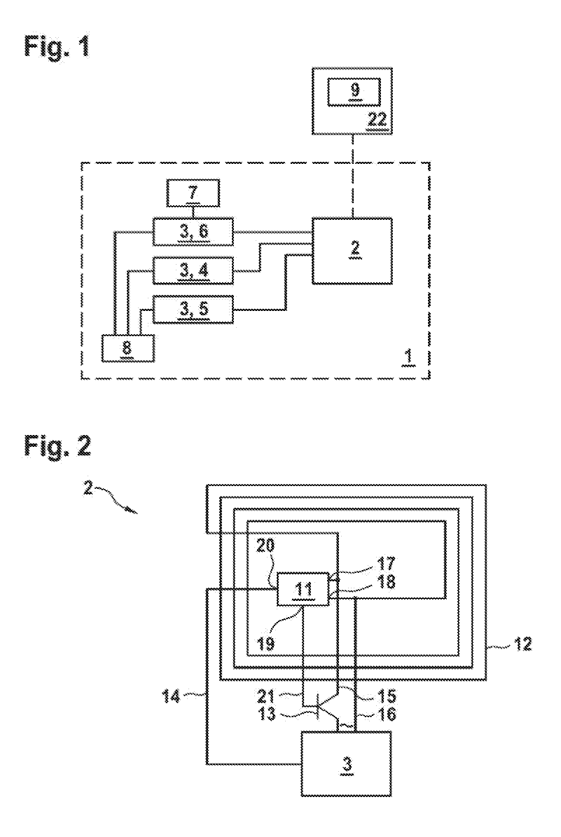

FIG. 1 shows an electronic part 1 having a near-field communication module 2. The near-field communication module 2 is connected to a transmission apparatus 22 using near-field communication, as indicated by a dashed line. The transmission apparatus 22 has an energy source 9. The electronic part 1 also has three electronic components 3. These are a sensor 4, a communication interface 5 and a computing module 6. The computing module 6 is connected to a memory 7. The electronic part 1 also has a battery 8 which can be used to supply the electronic components 3 with energy.

The electronic components 3 can (in particular if they are disconnected from the battery 8 by switches (not shown), for example, and/or if the battery 8 is discharged) be at least occasionally supplied with electrical energy via the near-field communication module 2.

FIG. 2 shows the near-field communication module 2 and one of the electronic components 3 of the electronic part 1 from FIG. 1. The near-field communication module 2 has a near-field microprocessor 11 and a coil 12.

The coil 12 is connected to the near-field communication processor 11 via a first connection 17 and a second connection 18. A first supply line 15 branches off at the first connection 17 of the near-field communication processor 11. A second supply line 16 branches off at the second connection 18 of the near-field communication processor 11. The electronic component 3 can be supplied with energy via the supply lines 15, 16.

A connection between the near-field communication module 2 and the electronic component 3 can be switched via a switch 13. For this purpose, the switch 13 is integrated in the first supply line 15. The switch is a transistor which can be controlled via a signal which can be output by the near-field communication module 2. This signal can be output by a third connection 19 of the near-field communication processor 11 and can be applied to a gate of the switch 13. For this purpose, the gate of the switch 13 is connected to the third connection 19 of the near-field communication processor 11 via a signal line 21.

The electronic component 3 is also connected to a fourth connection 20 of the near-field communication processor 11 and therefore to the near-field communication module 2 via a feedback channel 14.

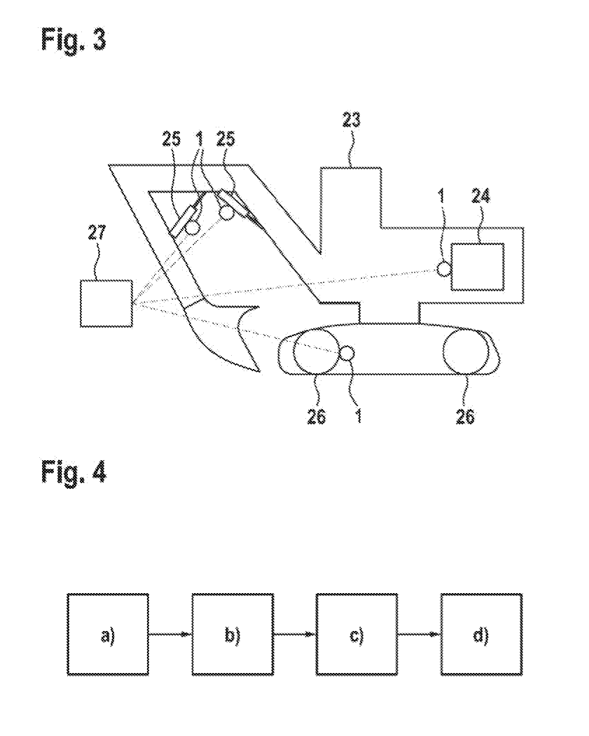

FIG. 3 shows a work machine 23. An electronic part 1 according to the embodiment from FIG. 1 is respectively provided on an engine 24, on two hydraulic units 25 and on a chain drive 26. Measured values can be recorded using the electronic parts 1 and can be transmitted to a receiver 27. For example, a temperature of the engine 24 and vibrations of the chain drive 26 and of the hydraulic units 25 can be measured.

FIG. 4 shows a method for supplying the electronic components 3 of the electronic part 1 from FIGS. 1 and 2 with electrical energy. This is carried out using the near-field communication module 2 and comprises the following method steps of:

a) receiving at least one request signal using the near-field communication module 2,

b) outputting at least one connection signal by means of the near-field communication module 2 in order to establish a connection between the near-field communication module 2 and the electronic components 3 if the at least one request signal was received in step a),

c) outputting electrical energy by means of the near-field communication module 2 for the purpose of supplying the electrical components 3, and

d) receiving at least one feedback signal from the at least one electronic component 3 using the near-field communication module 2.

Before step a), a power which is used to transfer electrical energy from the energy source 9 to the near-field communication module 2 is increased.

### LIST OF REFERENCE SIGNS

1 Apparatus
2 Near-field communication module
3 Electronic component
4 Sensor
5 Communication interface
6 Computing module
7 Memory
8 Battery
9 Energy source
11 Near-field processor
12 Coil
13 Switch
14 Feedback channel
15 First supply line
16 Second supply line
17 First connection
18 Second connection
19 Third connection
20 Fourth connection
22 Signal line
22 Transmission apparatus
23 Work machine
24 Engine
25 Hydraulic unit
26 Chain drive
27 Receiver

What is claimed is:

1. An electronic part, comprising:
at least one near-field communication module; and
at least one electronic component connected to the at least one near-field communication module such that the at least one electronic component is configured to be occasionally supplied with electrical energy via the at least one near-field communication module.

2. The electronic part of claim 1, wherein the at least one electronic component includes at least one of a sensor, a communication interface, a computing module, and a battery.

3. The electronic part of claim 1, further comprising:
at least one switch configured to switch the connection between the at least one near-field communication module and the at least one electronic component.

4. The electronic part of claim 3, wherein:
the at least one near-field communication module is configured to output a signal; and
the at least one switch is controlled via the signal.

5. The electronic part of claim 1, further comprising:
at least one feedback channel, wherein the at least one electronic component is additionally connected to the at least one near-field communication module via the at least one feedback channel.

6. A method for supplying at least one electronic component with electrical energy via at least one near-field communication module, comprising:
receiving at least one request signal using at least one near-field communication module;
in response to receiving the at least one request signal, outputting at least one connection signal via the at least one near-field communication module so as to establish a connection between the at least one near-field communication module and at least one electronic component; and
outputting electrical energy via the at least one near-field communication module so as to supply the at least one electrical component with the electrical energy.

7. The method of claim 6, further comprising:
prior to receiving the at least one request signal, increasing an electrical power used to transfer electrical energy from an energy source to the at least one near-field communication module.

8. The method of claim 6, further comprising:
receiving at least one feedback signal from the at least one electrical component using the at least one near-field communication module.

9. The method of claim 6, wherein the method is performed by a transmission apparatus.

10. A method of using a near-field communication module to supply at least one electronic component of an electronic part with electrical energy.
